(19) United States
(12) Patent Application Publication
(10) Pub. No.: US 2024/0338212 A1
(43) Pub. Date: Oct. 10, 2024

(54) PATTERN EXTRACTION VISUALIZATION DEVICE, PATTERN EXTRACTION VISUALIZATION METHOD, PATTERN EXTRACTION VISUALIZATION PROGRAM

(71) Applicant: Nippon Telegraph and Telephone Corporation, Tokyo (JP)

(72) Inventors: Naoki TAKE, Musashino-shi, Tokyo (JP); Yoshifumi KATO, Musashino-shi, Tokyo (JP); Miwaka OTANI, Musashino-shi, Tokyo (JP); Kiyotaka SAITO, Musashino-shi, Tokyo (JP); Satoshi KONDO, Musashino-shi, Tokyo (JP); Yu MIYOSHI, Musashino-shi, Tokyo (JP)

(21) Appl. No.: 18/292,701

(22) PCT Filed: Aug. 16, 2021
(86) PCT No.: PCT/JP2021/029922

§ 371 Date: Jan. 26, 2024

(51) Int. Cl. G06F 8/75; G06F 8/41

(52) U.S. Cl. CPC G06F 8/75; G06F 8/425

(57) ABSTRACT

A syntax analysis unit (12) that analyzes a plurality of source codes and classifies them into a plurality of patterns, a preprocessing unit (13) that abstracts each of the patterns classified by the syntax analysis unit (12), and an alignment derivation unit (15) that derives an alignment between the source codes for each of the abstracted patterns included in each of the source codes are included. Further, a visualization unit (16) that generates an image indicating the alignment in a predetermined format, and a display unit (17) that displays the image indicating the alignment are included.

### TECHNICAL FIELD

The present invention relates to a pattern extraction visualization device, a pattern extraction visualization method, and a pattern extraction visualization program for extracting, classifying, and visualizing a pattern of a source code.

### BACKGROUND ART

In order to simplify development of API adapters by an orchestrator, analyzing existing API adapters and automatically generating typical parts is generally performed.

However, when the number of existing API adapters is large, there is a problem that it takes a lot of labor to manually analyze all the API adapters.

NPL 1 discloses a technique for automatically extracting coding patterns from source codes by using a sequential pattern mining technique and supporting maintenance of the coding patterns performed by developers.

### CITATION LIST

### Non Patent Literature

[NPL 1] Takashi Ishio, Hironori Date, Tatsuya Miyake, and Katsuro Inoue, “Coding Pattern Extraction Using a Sequential Pattern Mining Approach,” Transactions of Information Processing Society of Japan, Vol. 50, No. 2, 860-871 (February 2009)

### SUMMARY OF INVENTION

### Technical Problem

However, in the above-described NPL 1, although it is possible to extract coding patterns frequently appearing in the source codes, it is difficult to extract coding patterns appearing at low frequencies. For this reason, there is a problem that the configuration of the entire source codes cannot be comprehensively understood and made into a rule.

The present invention has been made in view of the above circumstances, and an object of the present invention is to provide a pattern extraction visualization device, a pattern extraction visualization method, and a pattern extraction visualization program in which common coding patterns can be comprehensively extracted from existing source codes and visualized to be easily recognized by a user.

### Solution to Problem

A pattern extraction visualization device according to an aspect of the present invention is a pattern extraction visualization device that extracts and visualizes patterns included in a plurality of source codes, the device including: a syntax analysis unit that analyzes each of the source codes and classifies the source codes into a plurality of patterns; a preprocessing unit that abstracts each of the patterns classified by the syntax analysis unit; an alignment derivation unit that derives an alignment between the source codes for each of the abstracted patterns included in each of the source codes; a visualization unit that generates an image indicating the alignment in a predetermined format; and a display unit that displays the image indicating the alignment.

A pattern extraction visualization method according to an aspect of the present invention is a pattern extraction visualization method for visualizing patterns included in a plurality of source codes, the method including: analyzing each of the source codes and classifying the source codes into a plurality of patterns; abstracting each of the classified patterns; deriving an alignment between each of the source codes for each of the abstracted patterns included in each of the source codes; generating an image indicating the alignment in a predetermined format; and displaying the image indicating the alignment.

An aspect of the present invention is a pattern extraction visualization program for causing a computer to function as the pattern extraction visualization device.

### Advantageous Effects of Invention

According to the present invention, it is possible to comprehensively extract common coding patterns from existing source codes and visualize the coding patterns to be easily recognized by a user.

### BRIEF DESCRIPTION OF DRAWINGS

FIG. 1 is an explanatory diagram showing an example of generating source codes of API adapters from southbound specifications.

FIG. 2 is a block diagram showing a configuration of a pattern extraction visualization device according to an embodiment.

FIG. 3A is an explanatory diagram showing variable names or identifiers included in the source codes.

FIG. 3B is an explanatory diagram showing an example of abstracting patterns by masking the variable names or identifiers included in the source codes.

FIG. 4A is an explanatory diagram showing a first example of a source code including a preceding processing part, a parameter repacking part, and an API execution part.

FIG. 4B is an explanatory diagram showing a second example of source code including the preceding processing part, the parameter repacking part, and the API execution part.

FIG. 5A is an explanatory diagram showing an example in which the parameter repacking part shown in FIG. 4A is replaced with a symbol.

FIG. 5B is an explanatory diagram showing an example in which the parameter repacking part shown in FIG. 4B is replaced with a symbol.

FIG. 6 is an explanatory diagram showing an example of a process of replacing the parameter repacking part of the source code with a symbol.

FIG. 7 is an explanatory diagram showing an example of a data dependent diagram.

FIG. 8 is an explanatory diagram showing an example of a conversion pattern for each parameter.

FIG. 9 is an explanatory diagram showing patterns included in four source codes N1 to N4.

FIG. 10 is an explanatory diagram showing an example of displaying an alignment of the four source codes N1 to N4 in a diff format.

FIG. 11 is an explanatory diagram showing an example of displaying the alignment of the four source codes N1 to N4 in a graph format.

FIG. 12A is an explanatory diagram showing a procedure of creating a graph format alignment of the four source codes N1 to N4.

FIG. 12B is an explanatory diagram showing the procedure of creating the graph format alignment of the four source codes N1 to N4.

FIG. 13 is an explanatory view showing patterns displayed by drilling down.

FIG. 14 is a flowchart showing a processing procedure of the pattern extraction visualization device according to the present embodiment.

FIG. 15 is a block diagram showing a hardware configuration of an embodiment.

### DESCRIPTION OF EMBODIMENTS

An embodiment will be described below with reference to the drawings. First, an overview of the present embodiment will be described. In an orchestrator, in order to facilitate development of a new API adapter, by analyzing source code of existing API adapters and examining the whole structure of the source code and rules for individual processing, a development range at the time of developing the new API adapter may be reduced.

That is, the source codes are classified into a plurality of coding patterns, and the rules are examined for each coding pattern to support development of the new API adapter. The term “coding pattern” here is a code fragment constituting source code and indicates, for example, one sentence or one group of programs included in the source code. In the following description, the term “coding pattern” is simply abbreviated as a “pattern.”

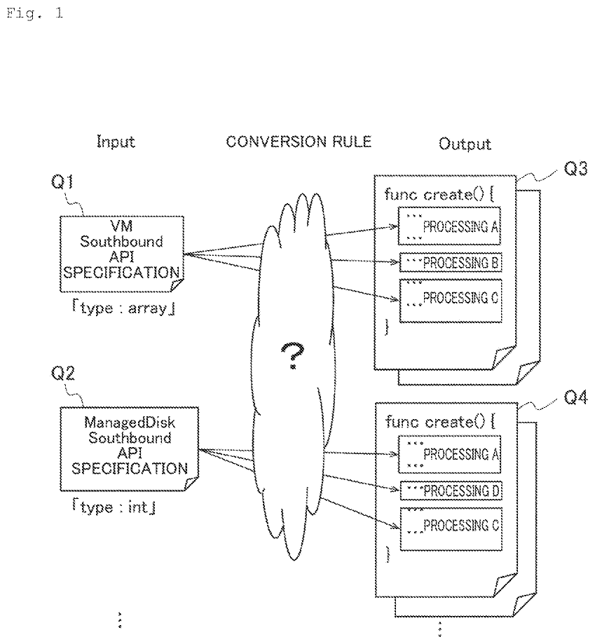

For example, as shown in FIG. 1, a case in which there are existing southbound API specifications Q1 and Q2, and source codes Q3 and Q4 of API adapters created by the respective specifications Q1 and Q2 is conceivable. It is assumed that “type; array” is stated in the specification Q1, and “type; int” is stated in the specification Q2.

The source code Q3 is analyzed and divided into patterns of processing A, processing B, and processing C. The source code Q4 is analyzed and divided into patterns of processing A, processing D, and processing C. As a result, in the southbound API specifications, it is possible to find a conversion rule in which processing B is executed when a certain item “type” is “array,” and processing D is executed when the item “type” is other than “array.” By incorporating such a rule into a software development kit (SDK) for developing adapters in advance, a development range at the time of developing a new API adapter can be reduced.

In the pattern extraction visualization device according to the present embodiment, a plurality of patterns are extracted from source codes of API adapters. That is, the pattern extraction visualization device classifies the source codes of the API adapters into a plurality of patterns and abstracts each pattern. Further, the patterns are classified into common patterns and individual patterns on the basis of the abstracted patterns and visualized to be easily recognized by a user. For example, the source codes Q3 and Q4 shown in FIG. 1 are analyzed, and patterns such as processing A, processing B, processing C, and the like are extracted and visualized. Also, the term “abstraction”” indicates abstracting patterns by replacing part of the patterns with arbitrary symbols or masking the patterns and considering patterns that are only partially different from each other to be the same.

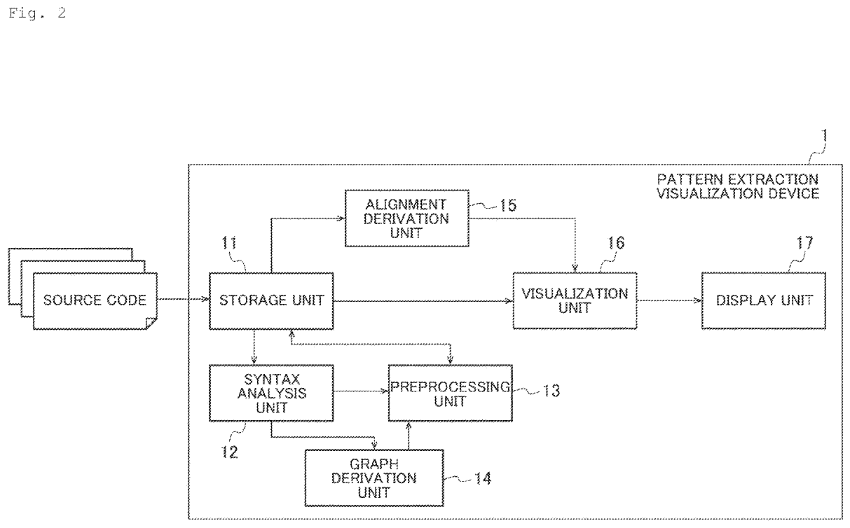

The pattern extraction visualization device according to the present embodiment will be specifically described below. FIG. 2 is a block diagram showing a configuration of the pattern extraction visualization device 1 according to the present embodiment. As shown in FIG. 2, the pattern extraction visualization device 1 includes a storage unit 11, a syntax analysis unit 12, a preprocessing unit 13, a graph derivation unit 14, an alignment derivation unit 15, a visualization unit 16, and a display unit 17.

The storage unit 11 acquires source codes of existing API adapters from the outside and stores the acquired source codes. The storage unit 11 stores information on analysis results obtained by the syntax analysis unit 12 and processing results obtained by the preprocessing unit 13, which will be described later.

The syntax analysis unit 12 analyzes each of the source codes stored in the storage unit 11 and classifies them into a plurality of patterns. The syntax analysis unit 12 performs, for example, static analysis on each of the source codes stored in the storage unit 11 and performs processing for converting the source codes into an abstract syntax tree (AST) format. The source codes converted into the AST format are outputted to the preprocessing unit 13 and the graph derivation unit 14.

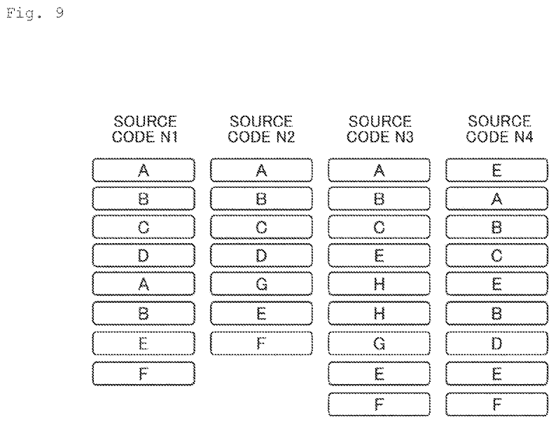

The preprocessing unit 13 abstracts each of the patterns classified by the syntax analysis unit 12. The preprocessing unit 13 extracts source codes which are not preprocessed among the source codes stored in the storage unit 11 and abstracts patterns by performing preprocessing such as masking on the patterns included in the extracted source codes. The preprocessing unit 13 stores the preprocessed source codes again in the storage unit 11. The preprocessing unit 13 abstracts the patterns included in the source codes and recognizes patterns which can be regarded as the same by abstracting them as common patterns. The preprocessing unit 13 classifies the source codes N1 to N4 into a plurality of patterns, for example, as shown in FIG. 9, which will be described later. In this case, common patterns are indicated by the same symbol.

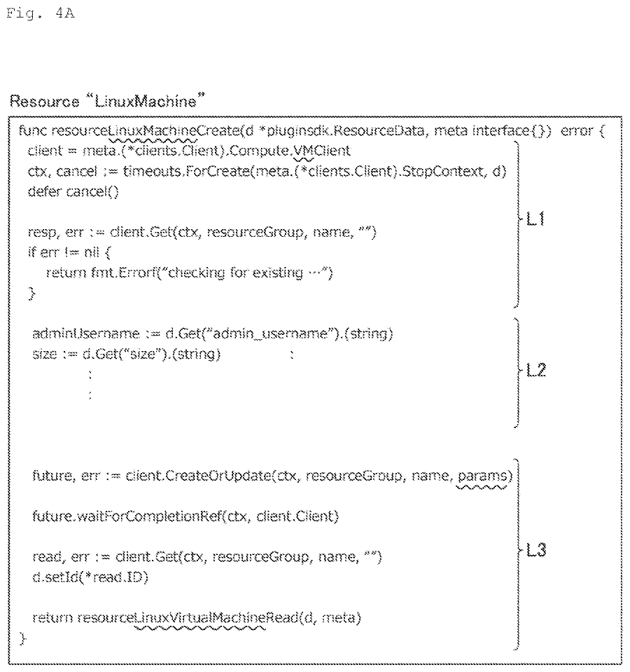

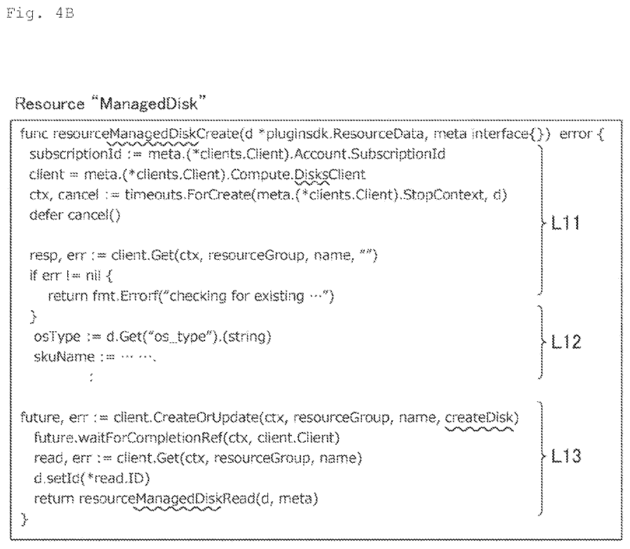

The preprocessing unit 13 may perform lexical analysis of the patterns and mask at least one of variable names and identifiers included in the patterns. The preprocessing unit 13 classifies each of the source codes into patterns of a preceding processing part (see L1 in FIG. 4A), a parameter repacking part (see L2 in FIG. 4A), and an API execution part (see L3 in FIG. 4A), and the patterns of the parameter repacking part may be replaced with symbols. When the graph derivation unit 14 is used, the preprocessing unit 13 reads a data dependent diagram from the graph derivation unit 14 and performs processing for specifying the parameter repacking part and mask processing.

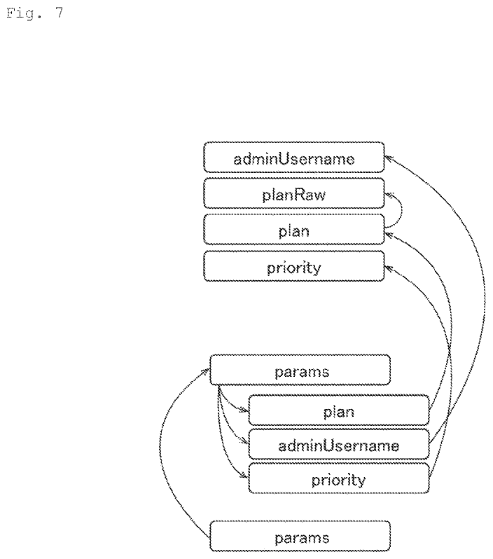

The graph derivation unit 14 generates the data dependent diagram on the basis of the parameter repacking part included in the source code. The graph derivation unit 14 creates the data dependent diagram by using AST calculated by the syntax analysis unit 12. Specifically, the graph derivation unit 14 generates the “data dependent diagram” shown in FIG. 7 (details will be described later).

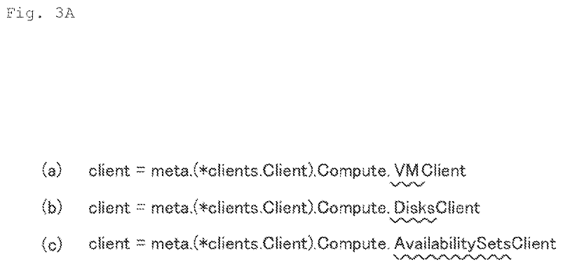

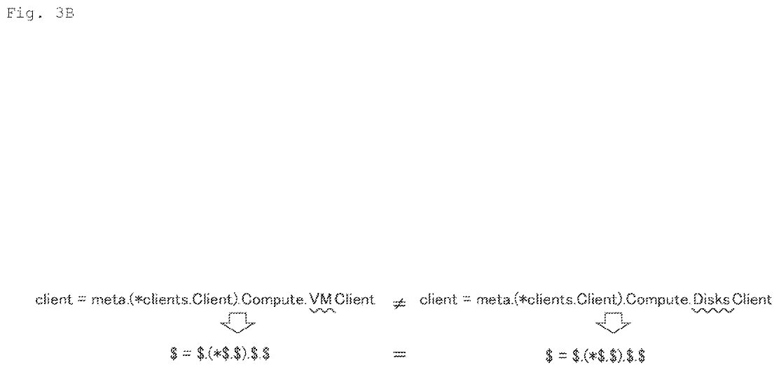

Detailed processing of the preprocessing unit 13 and the graph derivation unit 14 will be described below. FIG. 3A is an explanatory diagram showing an example in which the preprocessing unit 13 performs lexical analysis of the source code and masks the variable names or identifiers included in the source code. Symbols (a), (b), and (c) in FIG. 3A differ only in the variable names or identifiers “VM,” “Disk,” and “Availability Sets” (wavy lines in the figure), and the other words are the same. The preprocessing unit 13 replaces elements of each pattern with symbols in order to recognize these patterns as common. For example, patterns are replaced with patterns using symbol “$” as shown in FIG. 3B. As a result, the left side and the right side of FIG. 3B become the same pattern, and the patterns can be made common.

FIGS. 4A and 4B are explanatory diagrams showing examples of source codes classified into a plurality of patterns by the preprocessing unit 13. FIG. 4A shows a source code of “Linux Machine.” FIG. 4B shows a source code of the “Managed Disk.” The source codes shown in FIGS. 4A and 4B include preceding processing parts L1 and L11, parameter repacking parts L2 and L12, and API execution parts L3 and L13. The preceding processing parts L1 and L11 perform setting of time-outs and checking of existing resources.

The parameter repacking parts L2 and L12 take out parameters from orders for a northbound IF and repack or convert them into structures for southbound API execution.

The API execution parts L3 and L13 execute APIs by using the parameters created by the parameter repacking parts L2 and L12.

In the parameter repacking parts L2 and L12, since the number of parameters is different for each API adapter or the content of processing is different for each parameter, a correct correspondence relation may not be obtained when the source codes of the two adapters are directly compared with each other. For example, when FIGS. 4A and 4B are compared with each other, the parameter repacking parts L2 and L12 are different in the number of parameters and processing for each parameter from each other, which may result in inaccurate matching.

For this reason, the preceding processing parts L1 and L11 of FIG. 4A and FIG. 4B may be affected by the inaccurate matching of the parameter repacking parts L2 and L12, so that a correct correspondence relation between the preceding processing parts L1 and L11 may not be obtained. Similarly, the API execution parts L3 and L13 may be affected by the inaccurate matching of the parameter repacking parts L2 and L12, so that their correct correspondence relation may not be obtained.

Further, in the parameter repacking parts L2 and L12, the probability of accidental matching increases due to repetitions of syntactically similar descriptions, or the effect of abstraction (masking) through the lexical analysis, so that their correct correspondence relation may not be obtained.

The preprocessing unit 13 recognizes the processing parts of the parameter repacking parts L2 and L12 among the source codes of the adapters, replaces the parts with arbitrary characters (for example, “%%%”) set in common, and abstracts them, so that the correspondence relation of the whole structure can be easily obtained.

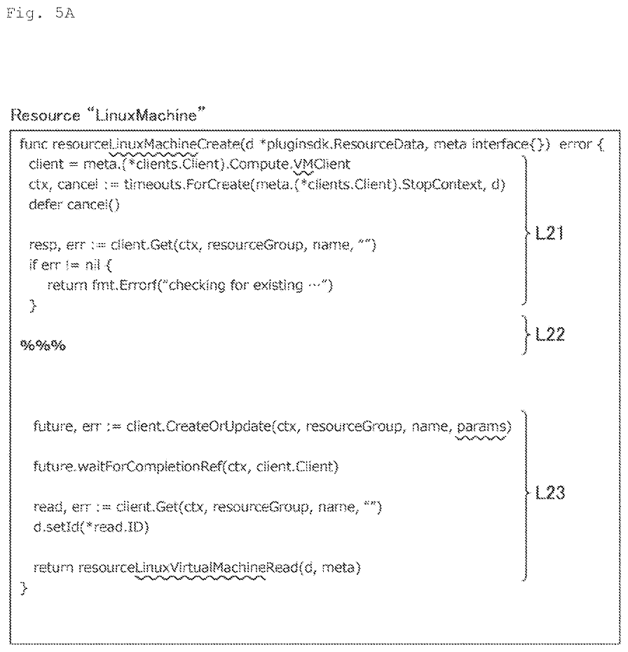

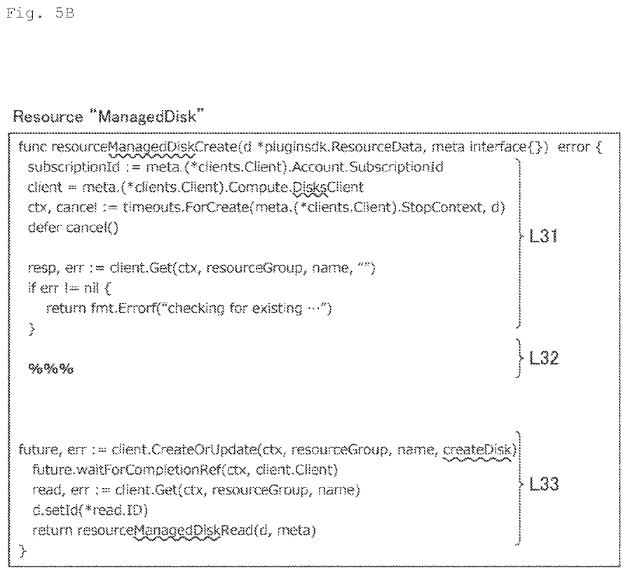

Specifically, as shown in FIG. 5A and FIG. 5B, the parameter repacking parts L22 and L32 are replaced with words of “%%%” In this way, the parameter repacking parts L22 and L32 existing in each source code can be recognized by correctly associating them with each other, and the API execution parts L23 and L33 of each source code can be accurately associated with each other without being affected by the parameter repacking parts L22 and L32.

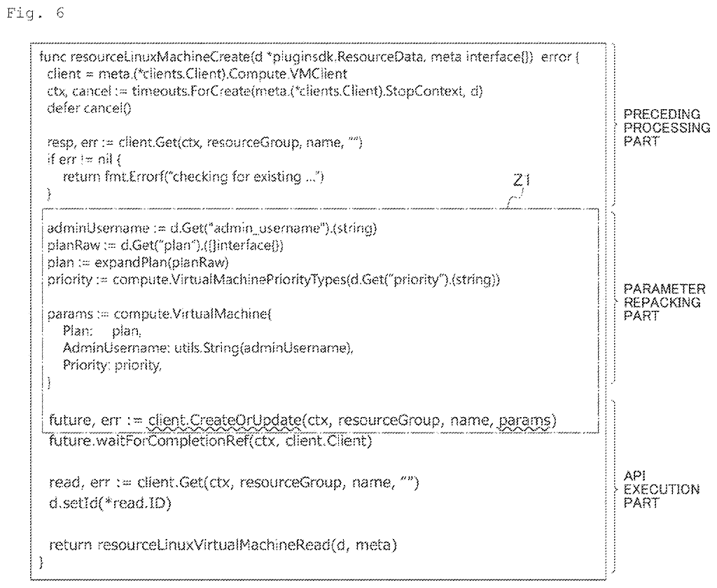

Specifically, as shown in FIG. 6, in an API execution process, a line that executes a “Client.CreateOrUpdate” method indicated by a wavy underline is retrieved. Then, a variable “params” used as an input parameter is specified.

From the above information, the data dependent diagram is created using, for example, a static analysis technique for a program. Specifically, in a parameter repacking part Z1 shown in FIG. 6, words and phrases such as “adminUsername,” “planRaw,” “plan,” “priority,” “parms,” and the like are described. The graph derivation unit 14 extracts the above-mentioned words and phrases to create the data dependent diagram as shown in FIG. 7.

The preprocessing unit 13 traces the variable “params” in the data dependent diagram shown in FIG. 7 and extracts all the parts in which the parameters are defined and set. The preprocessing unit 13 replaces the extracted parameter repacking part Z1 with a character “%%%” as shown in FIGS. 5A and 5B. In this way, the parameter repacking part Z1 can be easily replaced with the character “%%%.”

An API execution part shown in FIG. 6 can take a countermeasure without being affected by the parameter repacking part Z1. That is, for example, in FIGS. 5A and 5B, the API execution parts L23 and L33 can be made to correspond to each other.

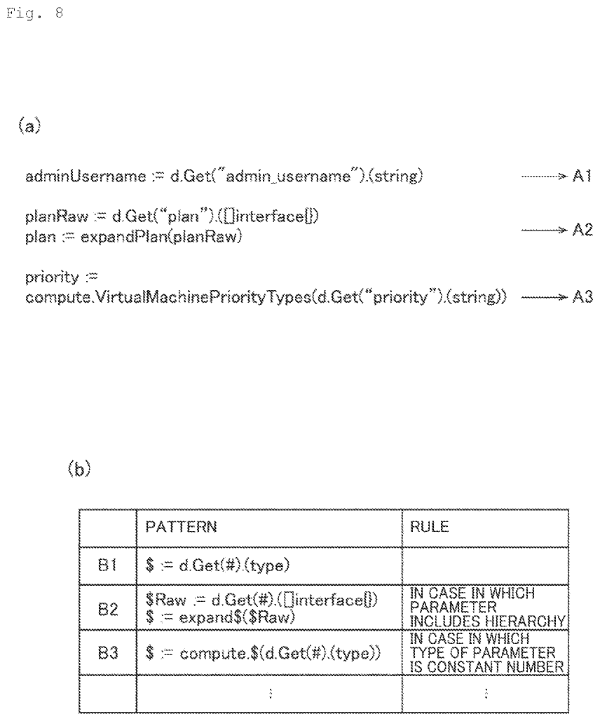

Further, as for the parameter repacking part, conversion patterns for each parameter may be recognized and presented. For example, “A1,” “A2,” and “A3” shown in FIG. 8(a) are assumed respectively to be “B1,” “B2,” and “B3” “ ” shown in FIG. 8(b).“ ” “ ” “B2” is a rule when a parameter includes a hierarchy. “B3” is a rule when a type of parameter is a constant.

In this way, the user can recognize repacking and conversion patterns for each parameter, and the examination of the conversion rule can be made more efficient.

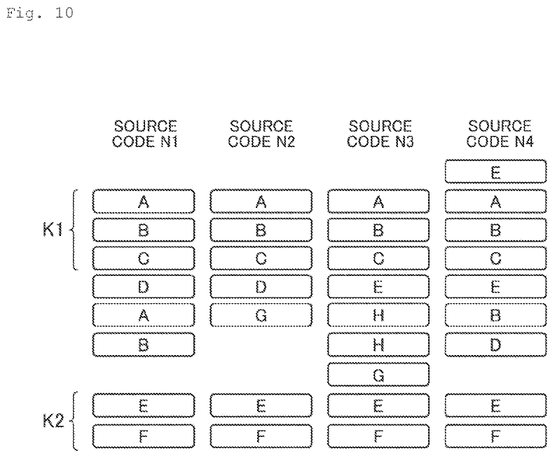

Returning to FIG. 2, the alignment derivation unit 15 derives an alignment between the source codes for the abstracted patterns included in the source codes. The term “alignment” indicates a correspondence relation of sequences of a plurality of patterns. For example, as shown in FIG. 10, which will be described later, it indicates the correspondence relation between patterns “A to G” included in the plurality of source codes N1 to N4. For deriving the alignment, for example, existing multiple alignment algorithms, such as “ClustalW,” “T-COFFEE,” “MAFFT,” and the like, which are multiple alignment programs, can be used. Also, since these algorithms are well-known techniques, detailed description thereof will be omitted.

The alignment derivation unit 15 derives the alignment between the source codes for the abstracted patterns included in the source codes N1 to N4 by using the algorithms. For example, it is assumed that there are for source codes N1 to N4 of four API adapters as shown in FIG. 9, which are classified into patterns A to G by the preprocessing unit 13. The alignment derivation unit 15 derives an alignment indicating a correspondence relation of the respective patterns “A” to “F” with respect to the source codes N1 to N4 of the four API adapters.

Specifically, since three patterns “A, B, and C” indicated by symbol K1 and two patterns “E and F” indicated by symbol K2 match each other in the source codes N1 to N4, the alignment derivation unit 15 derives an alignment in which these patterns correspond to each other.’

The visualization unit 16 shown in FIG. 2 generates an image indicating the alignment in a predetermined format. The display unit 17 displays the image indicating the alignment generated by the visualization unit 16. The visualization unit 16 may generate an image in at least one of a diff format and a graph format for the alignment. That is, the visualization unit 16 generates an image of the alignment of each pattern derived by the alignment derivation unit 15 in a form such as the diff format or graph format which is easy for the user to recognize and displays the image on the display unit 17. The visualization unit 16 visualizes the alignment by displaying the alignment on the display unit 17.

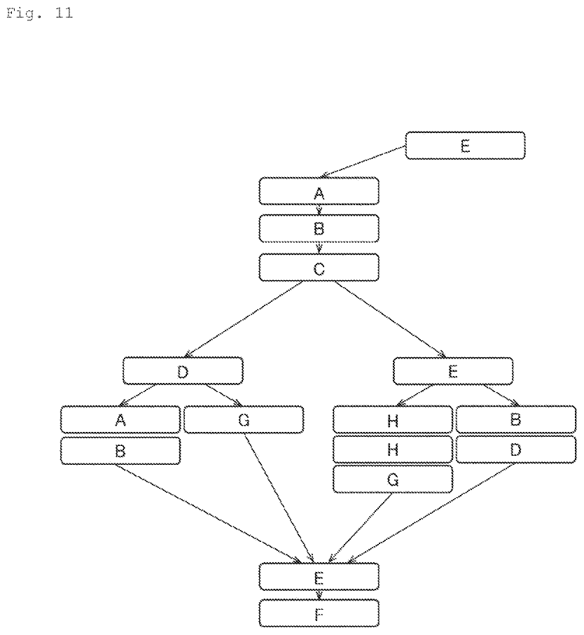

The visualization unit 16 generates images of the alignment in the diff format and the graph format on the basis of the patterns of the respective source codes N1 to N4 shown in FIG. 9. For example, as shown in FIG. 10, the visualization unit 16 displays the patterns included in each of the source codes N1 to N4 in the diff format that allows recognition of different points for each of the source codes N1 to N4. As another example, the visualization unit 16 displays the patterns included in each of the source codes N1 to N4 in a graph format as shown in FIG. 11.

FIG. 10 is an explanatory diagram showing an example of a display image in the diff format. As shown in FIG. 10, in each of the source codes N1 to N4, the patterns “A, B, and C” and the patterns “E and F” match each other. In the diff format, an image in which these patterns “A, B, C, E, and F” “are arranged in a horizontal direction is formed, so that the user can easily recognize the patterns common to the source codes N1 to N4.

FIG. 11 is an explanatory diagram showing an example of a display image in the graph format. As shown in FIG. 11, the patterns that match each other in each of the source codes N1 to N4 are assumed to be images in the graph format. By using the graph format, the user can easily recognize the common patterns and non-common patterns in the source codes N1 to N4.

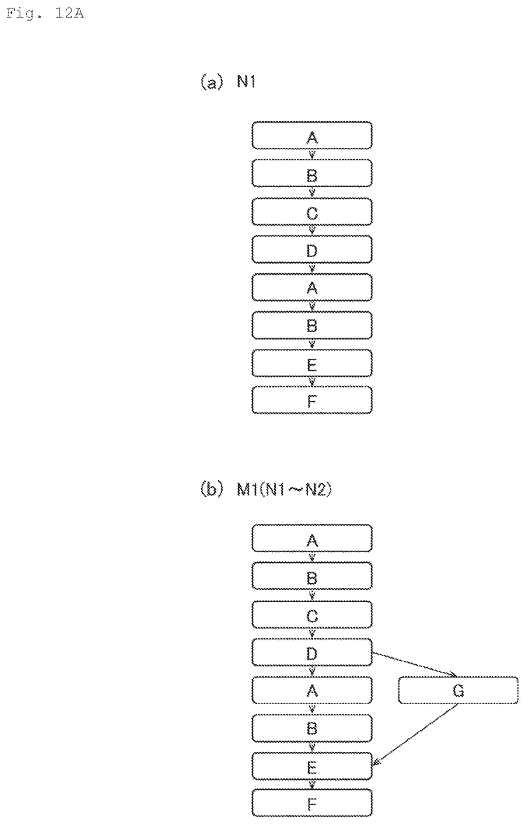

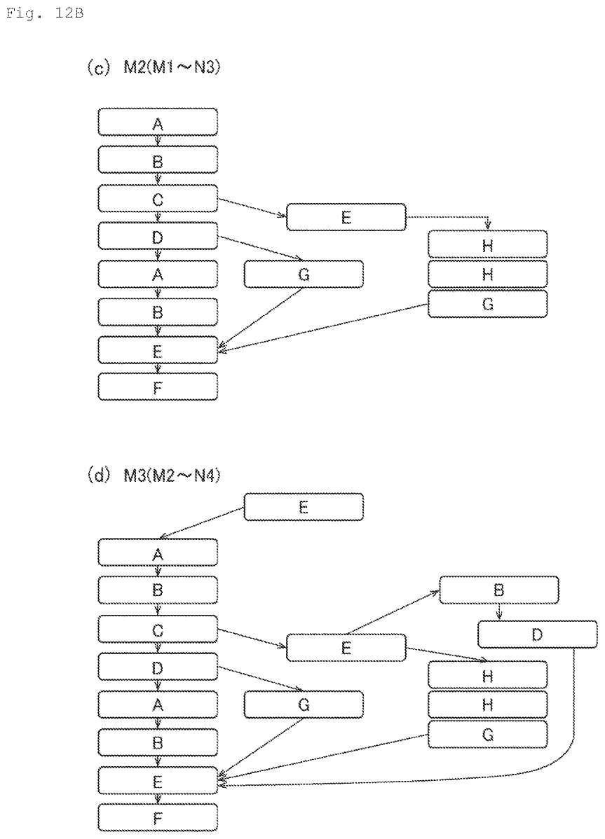

FIGS. 12A and 12B are explanatory diagrams showing a procedure of generating the display image in the graph format shown in FIG. 11. The visualization unit 16 compares the n-th source code with the (n−1)-th source code and aggregates common patterns to generate new nodes and edges.

As shown in FIG. 12A(a), the visualization unit 16 makes a graph in which the source code N1 is shown in a row as it is.

As shown in FIG. 12A(b), the visualization unit 16 generates graph format data M1 by comparing the source codes N2 and N1. When the source codes N1 and N2 are compared, “A to D” and “E and F” match each other, and “A and B” in the middle stage is changed to “G.” Accordingly, as shown in FIG. 12A(b), data M1 is generated by adding nodes of the pattern “G” and an edge connecting the nodes of the pattern “G” to the source code N1 shown in FIG. 12(a).

As shown in FIG. 12B(c), the visualization unit 16 generates graph format data M2 by comparing the source codes N3 and N2. When the source codes N3 and N2 are compared, “A to C” and “E and F” match each other, and “D and G” are changed to “E, H, H, and G.” Accordingly, the data M2 shown in the FIG. 12B(c) is generated.

As shown in FIG. 12B(d), the visualization unit 16 generates graph format data M3 by comparing the source codes N4 and N3. When the source codes N4 and N3 are compared, “A to C” and “E and F” “match each other, “E” is added, and “H, H, and G” are changed to “B and D.” Accordingly, the data M3 shown in FIG. 12B(d) is generated. The syntax analysis unit 12 generates the graph format data M3 in which the four source codes N1 to N4 are abstracted by the above procedure.

The user can recognize the alignment of the source codes of each API adapter by visually recognizing the alignment displayed on the display unit 17.

When a selection input is performed to a pattern displayed on the display unit 17, the visualization unit 16 generates an image obtained by drilling down the selected and input pattern and displays it on the display unit 17. That is, the visualization unit 16 has a function of drilling down and displaying the selected pattern when a predetermined pattern (node) is selected from the alignment displayed on the display unit 17. For example, when the user selects, for example, the pattern “A” among the patterns displayed in a graph shown in FIG. 12B(d), the visualization unit 16 drills down on this pattern and displays it on the display unit 17. The original program can be confirmed by drilling down.

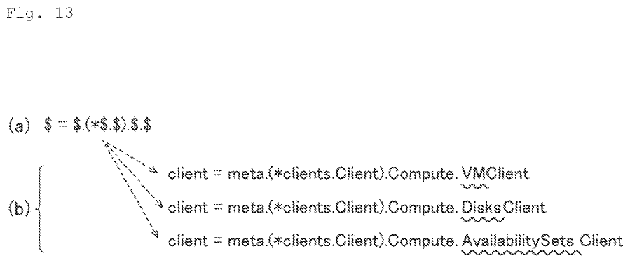

For example, when the graph format data M3 shown in FIG. 12B(d) is displayed on the display unit 17, and the user selects the pattern “A” in the display image, “$=$. (*$. $). $. $” is displayed as shown in FIG. 13(a). The user can recognize the format of the pattern “A” by viewing this display.

Further, by selecting the display of the above (a) displayed on the display unit 17, a specific coding pattern is displayed as shown in FIG. 13(b). The user can recognize a specific program by viewing this display.

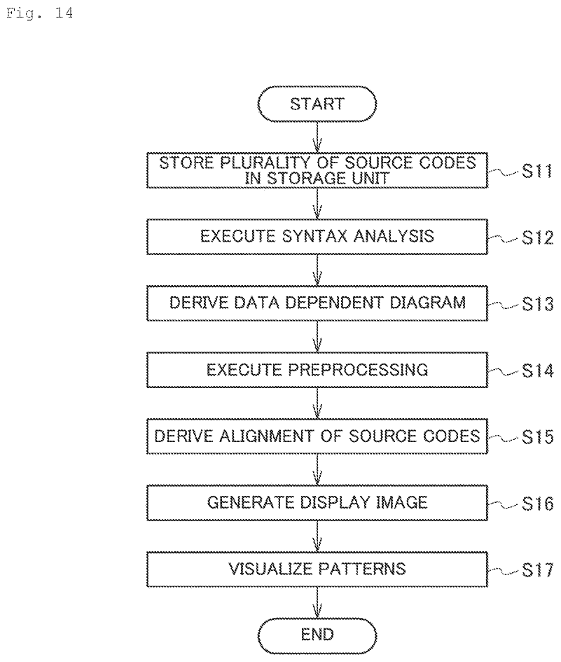

Next, a processing procedure of the pattern extraction visualization device 1 according to the present embodiment configured as described above will be described below with reference to a flowchart shown in FIG. 14.

First, in step S11 in FIG. 14, the storage unit 11 acquires and stores a plurality of source codes.

In step S12, the syntax analysis unit 12 executes syntax analysis on each of the source codes stored in the storage unit 11. The syntax analysis unit 12 executes processing for converting, for example, the source codes into an AST format.

The source codes converted into the AST format are outputted to the preprocessing unit 13 and the graph derivation unit 14.

In step S13, the graph derivation unit 14 derives a data dependent diagram. For example, the data dependent diagram shown in FIG. 7 is derived as described above.

In step S14, the preprocessing unit 13 applies preprocessing to each of the source codes stored in the storage unit 11. More specifically, the preprocessing unit 13 extracts source codes which are not preprocessed among the source codes stored in the storage unit 11, performs processing such as masking on patterns included in the extracted source codes to abstract the patterns and stores them in the storage unit 11 again. As a result, for example, as shown in FIG. 9, the source codes N1 to N4 are classified into patterns indicated by A to G. In FIG. 9, patterns having the same reference numerals are common patterns.

In step S15, the alignment derivation unit 15 derives an alignment of the patterns abstracted by the preprocessing unit 13. For example, as shown in FIG. 10, the alignment derivation unit 15 derives an alignment indicating a correspondence relation of the patterns included in the source codes N1 to N4 of four API adapters in a diff format.

In step S16, the visualization unit 16 generates an image, in which each pattern is set to a predetermined display format, on the basis of the alignment derived by the alignment derivation unit 15. For example, an image in the diff format shown in FIG. 10 or the graph format shown in FIG. 11 is generated.

In step S17, the visualization unit 16 displays the image generated by the processing of the step S16 on the display unit 17 to visualize the image. By visually recognizing the image, the user can recognize common patterns included in the source codes of the plurality of API adapters.

As described above, the pattern extraction visualization device 1 according to the present embodiment is a pattern extraction visualization device that extracts and visualizes patterns included in a plurality of source codes, the device including: the syntax analysis unit 12 that analyzes each of the source codes and classifies the source codes into a plurality of patterns; a preprocessing unit 13 that abstracts each of the patterns classified by the syntax analysis unit 12; an alignment derivation unit 15 that derives an alignment between the source codes for each of the abstracted patterns included in each of the source codes; a visualization unit 16 that generates an image indicating the alignment in a predetermined format; and a display unit 17 that displays the image indicating the alignment.

In the pattern extraction visualization device 1 according to the present embodiment, the source codes of the existing API adapters are classified into the plurality of patterns, and each of the patterns is abstracted to extract common parts. In the pattern extraction visualization device 1 according to the present embodiment, patterns common to each of the source codes are displayed and visualized on the display unit 17 in a way that is easy for a user to recognize. By viewing the display, the user can easily recognize the common patterns and individual patterns included in the plurality of source codes.

Since the visualization unit 16 displays the alignment on the display unit 17 in a diff format or graph format at the time of displaying the alignment, the common patterns and the individual patterns can be visualized in a more easily recognizable manner.

Since the preprocessing unit 13 analyzes syntax words and phrases included in the source codes and masks variable names and identifiers included in the patterns, the plurality of patterns can be easily abstracted.

The preprocessing unit 13 classifies each of the source codes into patterns of the preceding processing part, the parameter repacking part, and the API execution part and replaces the pattern of the parameter repacking part with a symbol.

Specifically, as shown in FIGS. 5A and 5B, the parameter repacking part is replaced with “%%.” For this reason, the preceding processing part and the API execution part can accurately associate the common patterns included in two source codes without being affected by the parameter repacking part.

When a selection input is performed to the patterns displayed on the display unit 17, the visualization unit 16 displays an image obtained by drilling down the selected and input patterns on the display unit 17. For this reason, the user can easily recognize detailed contents of each pattern.

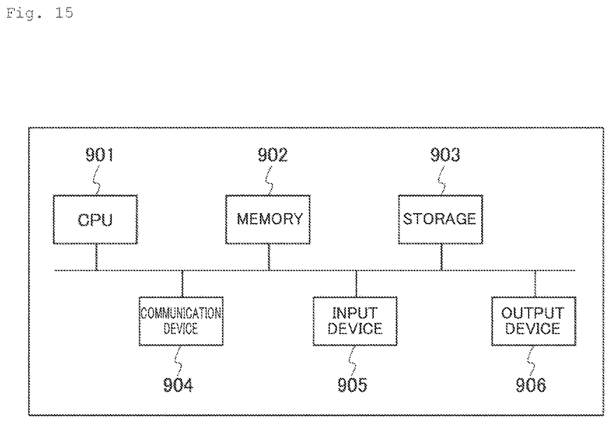

For the pattern extraction visualization device 1 according to the present embodiment described above, for example, a general-purpose computer system which includes, as shown in FIG. 15, a central processing unit (CPU; a processor) 901, a memory 902, a storage 903 (a hard disk drive (HDD) or a solid state drive (SSD)), a communication device 904, an input device 905, and an output device 906 can be used. The memory 902 and the storage 903 are storage devices. In this computer system, each function of the pattern extraction visualization device 1 is realized by the CPU 901 executing a predetermined program loaded to the memory 902.

Also, the pattern extraction visualization device 1 may be implemented by one computer, or may be implemented by a plurality of computers. In addition, the pattern extraction visualization device 1 may be a virtual machine installed in a computer.

Further, a program for the pattern extraction visualization device 1 can be stored in computer-readable recording media such as an HDD, an SSD, a universal serial bus (USB) memory, a compact disc (CD), and a digital versatile disc (DVD) or distributed over a network.

Also, the present invention is not limited to the above embodiment, and various modifications can be made within the scope of the gist thereof.

### REFERENCE SIGNS LIST

1 Pattern extraction visualization device
11 Storage unit
12 Syntax analysis unit
13 Preprocessing unit
14 Graph derivation unit
Alignment derivation unit
16 Visualization unit
17 Display unit

1. A pattern extraction visualization device for extracting and visualizing patterns included in a plurality of source codes, comprising:
a syntax analysis unit, including one or more processors, configured to analyze each of the source codes and classifies the source codes into a plurality of patterns;
a preprocessing unit, including one or more processors, configured to abstract each of the patterns classified by the syntax analysis unit;
an alignment derivation unit, including one or more processors, configured to derive an alignment between the source codes for each of the abstracted patterns included in each of the source codes;
a visualization unit, including one or more processors, configured to generate an image indicating the alignment in a predetermined format; and
a display unit, including one or more processors, configured to display the image indicating the alignment.

2. The pattern extraction visualization device according to claim 1, wherein the predetermined format is at least one of a diff format and a graph format.

3. The pattern extraction visualization device according to claim 1, wherein the preprocessing unit is configured to perform lexical analysis on the patterns and mask at least one of a variable name and an identifier included in the patterns.

4. The pattern extraction visualization device according to claim 1, wherein the preprocessing unit is configured to classify each of the source codes into patterns of a preceding processing part, a parameter repacking part, and an API execution part and replace the pattern of the parameter repacking part with a symbol.

5. The pattern extraction visualization device according to claim 4, further comprising a graph derivation unit, including one or more processors, configured to generate a data dependent diagram on the basis of the parameter repacking parts included in the source codes,
wherein the preprocessing unit is configured to abstract each of the patterns classified by the syntax analysis unit with reference to the data dependent diagram.

6. The pattern extraction visualization device according to claim 1, wherein when a selection input is performed on the patterns displayed on the display unit, the visualization unit is configured to generate an image obtained by drilling down the selected and input patterns and display the image on the display unit.

7. A pattern extraction visualization method for extracting and visualizing patterns included in a plurality of source codes, comprising:
analyzing each of the source codes and classifying the source codes into a plurality of patterns;
abstracting each of the classified patterns;
deriving an alignment between each of the source codes for each of the abstracted patterns included in each of the source codes;
generating an image indicating the alignment in a predetermined format; and
displaying the image indicating the alignment.

8. A non-transitory computer-readable storage medium storing a pattern extraction visualization program that causes a computer to perform operations comprising:
analyzing each of the source codes and classifying the source codes into a plurality of patterns;
abstracting each of the classified patterns;
deriving an alignment between each of the source codes for each of the abstracted patterns included in each of the source codes;
generating an image indicating the alignment in a predetermined format; and
displaying the image indicating the alignment.

9. The pattern extraction visualization method according to claim 7, wherein the predetermined format is at least one of a diff format and a graph format.

10. The pattern extraction visualization method according to claim 7, further comprising:
performing lexical analysis on the patterns and masking at least one of a variable name and an identifier included in the patterns.

11. The pattern extraction visualization method according to claim 7, further comprising:
classifying each of the source codes into patterns of a preceding processing part, a parameter repacking part, and an API execution part and replace the pattern of the parameter repacking part with a symbol.

12. The pattern extraction visualization method according to claim 11, further comprising:
generating a data dependent diagram on the basis of the parameter repacking parts included in the source codes; and
abstracting each of the patterns classified by the syntax analysis unit with reference to the data dependent diagram.

13. The pattern extraction visualization method according to claim 7, further comprising:
when a selection input is performed on the patterns displayed, generating an image obtained by drilling down the selected and input patterns and displaying the image.

12. The non-transitory computer-readable storage medium according to claim 8, wherein the predetermined format is at least one of a diff format and a graph format.

13. The non-transitory computer-readable storage medium according to claim 8, wherein the operations further comprise:
performing lexical analysis on the patterns and masking at least one of a variable name and an identifier included in the patterns.

14. The non-transitory computer-readable storage medium according to claim 8, wherein the operations further comprise:
classifying each of the source codes into patterns of a preceding processing part, a parameter repacking part, and an API execution part and replace the pattern of the parameter repacking part with a symbol.

15. The non-transitory computer-readable storage medium according to claim 14, wherein the operations further comprise:
generating a data dependent diagram on the basis of the parameter repacking parts included in the source codes; and
abstracting each of the patterns classified by the syntax analysis unit with reference to the data dependent diagram.

16. The non-transitory computer-readable storage medium according to claim 8, wherein the operations further comprise:
when a selection input is performed on the patterns displayed, generating an image obtained by drilling down the selected and input patterns and displaying the image.
